(19) United States
(12) Patent Application Publication
(10) Pub. No.: US 2003/0209861 A1
(43) Pub. Date: Nov. 13, 2003

(54) Metal end cap seal with pressure trap

(75) Inventors: Kendall E. Keene, Houston, TX (US); Danny Kay Wolff, Houston, TX (US)

Correspondence Address: CONLEY ROSE, P.C., P. O. BOX 3267, HOUSTON, TX, 77253-3267, US

(73) Assignee: Cooper Cameron Corporation, Houston, TX (US)

(21) Appl. No.: 10/143,277

(22) Filed: May 10, 2002

(51) Int. Cl. F16L 21/05

(52) U.S. Cl. 277/603

(57) ABSTRACT

Accordingly, there is provided herein a metal end cap seal assembly for sealing the annulus between two tubular members that has improved sealing abilities at a wide range of temperatures. The metal end cap seal generally comprises a resilient ring with a metal end caps on either end. The inner diameter of the resilient ring has one or more circumferential cavities open to the inner diameter and connected to the outer diameter by one or more radial holes. After the seal is energized, a high pressure is applied to the seal so that the pressure will migrate past the nose of the seal, through the radial holes, and into the groove. The groove is shaped so that, once the high pressure is relieved, the pressure within the groove will become trapped. This trapped pressure acts as a source of stored energy within the seal and causes the seal to be energized to a level that is greater than the energization capable without the trapped pressure. Therefore the sealing assembly is able to more effectively function at low temperatures.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The present invention relates generally to seals, and more particularly to well sealing assemblies that seal off an annulus between two tubular members, especially in wellhead tubing hanger applications. Still more particularly, the present invention relates to metal end cap seal assemblies generally comprising a resilient seal ring with metallic caps affixed to either end of the seal ring.

A hydrocarbon well is normally produced through a tubing string rather than through the casing that lines the wellbore. A well will often have several strings of tubing through which production operations can be supported. Because each string of tubing is often used independently of adjacent strings, the annulus between adjacent, concentric strings of tubing must be reliably sealed. These seals must be able to withstand high pressures, corrosive environments, and a wide range of temperatures. It is also desirable to have a sealing mechanism that will maintain a seal without a continuous compressive load, which allows for simplification of the sealing mechanism as well as the setting and retrieving procedures.

One such sealing mechanism is disclosed in U.S. Pat. No. 4,496,162, issued to McEver et al., and incorporated herein by reference for all purposes. A simplified sealing mechanism, as is well known in the is shown in FIG. 1. Sealing assembly 10 is disposed within a housing 12 and is shown in an unset position. Housing 12 has a tapered surface 28 and a sealing surface 29. Sealing assembly 10 generally includes tubular body 18 having an outer surface 26, back-up ring 32, setting sleeve 38, and metal end cap seal 36. Back-up ring 32 releasably connects to surface 26 by shear pin 34 and is positioned below seal 36. Setting sleeve 38 is disposed above seal 36. Metal end cap seal 36 generally comprises a resilient ring 58 with metallic caps 50, 52 disposed on the top and bottom of ring 58.

Now referring to FIG. 2, the sealing assembly 10 is shown in a set position. Setting sleeve 38 has been moved downward, shearing pin 34 and moving metal end cap seal 36 into a position between housing sealing surface 29 and surface 26. In the set position, resilient ring 58 is compressed between body 18 and housing 12 creating a force on legs 56 of end caps 50, 52, that pushes legs 56 outward toward their related sealing surfaces and creates metal-to-metal seals between end caps 50 and 52 and the sealing surfaces of housing 12 and body 18. By having an energized elastomeric seal effectively protected by metal-to-metal seals, this sealing arrangement avoids extrusion of the resilient ring and protects the resilient ring from exposure to wellbore fluids.

Sealing assemblies utilizing metal end cap seals, such as that described above, have found widespread use in tubing hanger applications in a variety of operating conditions by providing seal assemblies that can be easily energized, avoid seal extrusion, and can be easily retrieved. Wells today are being drilled in increasingly harsh environments and the conditions in which these sealing assemblies have to perform is constantly evolving. One area in which the performance of metal end cap seal rings has been problematic is in low temperature applications where energization of the resilient material becomes difficult due to reduced temperatures or other environmental effects.

The present invention is directed to improved methods and apparatus for metal end cap seal rings that seek to overcome these and other limitations of the prior art. In particular the present invention is directed to providing an improved metal end cap seal design that is more easily energized at low temperatures.

### SUMMARY OF THE PREFERRED EMBODIMENTS

Accordingly, there is provided herein a metal end cap seal assembly for sealing the annulus between two tubular members that has improved sealing abilities at a wide range of temperatures. The metal end cap seal generally comprises a resilient ring with a metal end caps on either end. The inner diameter of the resilient ring has one or more circumferential grooves open to the inner diameter and connected to the outer diameter by one or more radial holes through the ring. The groove is preferably a dovetail shape.

After the seal is energized, high pressure is applied to annular area so that pressure will migrate past the nose of the seal, through the radial holes, and into the groove. As the high pressure is relieved, the pressure within the groove will become trapped and act as a source of stored energy within the seal, thus causing the seal to be energized to a level that is greater than the energization capable without the trapped pressure. Therefore, the sealing assembly is able to more effectively function at low temperatures.

Thus, the present invention comprises a combination of features and advantages that enable it to substantially advance metal end cap seal art by providing apparatus for increasing the range of temperature performance. These and various other characteristics and advantages of the present invention will be readily apparent to those skilled in the art upon reading the following detailed description of the preferred embodiments of the invention and by referring to the accompanying drawings.

### BRIEF DESCRIPTION OF THE DRAWINGS

For a more detailed understanding of the preferred embodiments, reference is made to the accompanying Figures, wherein:

FIG. 1 is a partial sectional view of a sealing assembly in the unset position;

FIG. 2 is a partial sectional view of a sealing assembly in the set position;

FIG. 3 is a partial sectional view of one embodiment of a metal end cap seal;

FIG. 4 is an enlarged partial sectional view of the metal end cap seal of FIG. 3, shown in the set position; and

FIG. 5 is a partial sectional view of an alternative embodiment of a metal end cap seal.

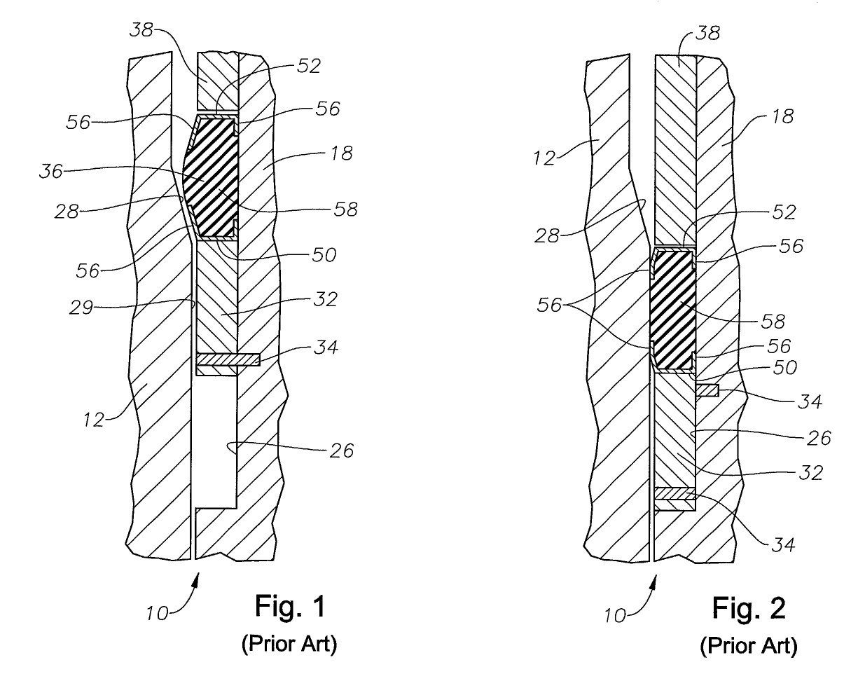

### DETAILED DESCRIPTION OF THE PREFERRED EMBODIMENTS

In the description that follows, like parts are marked throughout the specification and drawings with the same reference numerals, respectively. The drawing figures are not necessarily to scale. Certain features of the invention may be shown exaggerated in scale or in somewhat schematic form and some details of certain elements may be omitted in the interest of clarity and conciseness.

The present invention relates to methods and apparatus for providing an annular seal between concentric tubular members. The present invention is susceptible to embodiments of different forms. There are shown in the drawings, and herein will be described in detail, specific embodiments of the present invention with the understanding that the present disclosure is to be considered an exemplification of the principles of the invention, and is not intended to limit the invention to that illustrated and described herein.

In particular, various embodiments of the present invention are described as being used in oilfield applications, in particular as a tubing hangar seals, but the use of the present invention is not limited to either tubing hangars or oilfield applications and may used in any applicable sealing arrangement. Additionally, although the preferred embodiments are described with certain features appearing on either the inside or outside diameter of the seal, it is understood that these features can be used on either diameter in any combination as may be appropriate for a given application. It is to be fully recognized that the different teachings of the embodiments discussed below may be employed separately or in any suitable combination to produce desired results.

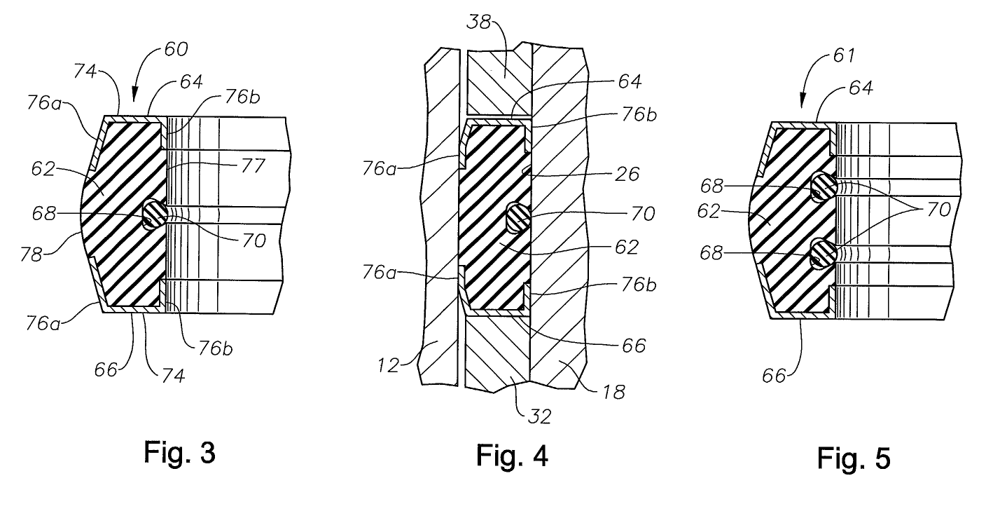

Referring now to FIG. 3, a partial cross-section of one embodiment of a metal end cap seal assembly 60 is shown in an as-constructed configuration. Metal end cap seal assembly 60 includes a resilient ring 62 having metal end caps 64 and 66 preferably bonded to its upper and lower ends. End caps 64 and 66 have a central portion 74 with inner legs 76b and outer legs 76a extending in a direction toward the mid point of resilient ring 62. Outer, central portion 78 of resilient ring 62 is convex shaped, while inner, central portion 77 of resilient ring 62 is generally flat and a circumferential groove 68 that is open to the inside of ring 61. A plurality of holes 70 extend from convex surface 78 to cavity 68, providing a pathway for fluid to pass. It is preferred that resilient ring 62 be made of an elastomeric material, such as a nitrile rubber, and metal end caps be constructed from a type 316 stainless steel.

On inner surface 77 there is formed a groove 68 that increases in width as the depth of the groove increases. Groove 68 is sized to maintain a volume of rubber sufficient to seal at the operating conditions. The corners of groove 68 are preferably radiused to decrease stress concentration in the corners. One or more radial holes 70 extend from groove 68 to outside surface 78. As shown in FIG. 5, resilient ring 62 may also have small protrusions 69 on the inside surface 77 that provide increased interference with the sealing surface.

Metal end cap assembly 60 is shown in a set position in FIG. 4. Metal end cap seal assembly 60 is shown in relationship with setting sleeve 38 and back-up ring 32 forming a seal between the housing 12 and surface 26 of body 18. Resilient ring 62 is energized by being compressed between housing 12 and body 18. Metal end caps 64 and 66 are expanded and pushed against housing 12 and body 18 by energized resilient ring 62. Metal-to-metal seals are created between the legs 76a, 76b and the sealing surfaces of housing 12 and body 18.

Groove 68 forms a circumferential cavity within resilient ring 62 after seal 60 has been energized. Application of high pressure, such as that typically encountered during testing, to seal 60 causes pressure to migrate past the edge of resilient ring 62, through radial holes 70, and into the groove 68. As the pressure is reduced the fluid within groove 68 will become trapped, creating a sealed cavity 72 within the interior of resilient ring 62 with high pressure trapped within the cavity. This pressure cavity 72 exerts an energizing force onto resilient ring 62, thus providing additional compression to the resilient ring and improving the performance at all temperatures.

The embodiments set forth herein are merely illustrative and do not limit the scope of the invention or the details therein. For example, while it is preferred that the o-ring have a standard circular cross-section, it is understood that certain service requirements may support the use of seals of different shapes or structures. It will be appreciated that many other modifications and improvements to the disclosure herein may be made without departing from the scope of the invention or the inventive concepts herein disclosed. Because many varying and different embodiments may be made within the scope of the inventive concept herein taught, including equivalent structures or materials hereafter thought of, and because many modifications may be made in the embodiments herein detailed in accordance with the descriptive requirements of the law, it is to be understood that the details herein are to be interpreted as illustrative and not in a limiting sense.

What is claimed is:

1. A seal assembly comprising:
a resilient ring having a generally flat first side surface, a convex second side surface, an upper surface, and a lower surface;
one or more circumferential grooves on the first side surface of ring;
one or more radial holes providing a fluid path between said circumferential groove and the convex second side;
a first annular end cap bonded to the upper surface of said resilient ring and having a first leg along a portion of the first side surface and second leg along a portion of the second side surface; and
a second annular end cap bonded to the lower surface of said resilient ring and having a first leg along a portion of the first side surface and second leg along a portion of the second side surface.

2. The assembly of claim 1 where the first side surface is the outer surface of said resilient ring.

3. The assembly of claim 2 wherein said circumferential groove is a dovetail groove.

4. The assembly of claim 2 further comprising one or more circumferential protrusions on said first surface.

5. The assembly of claim 1 where the first side surface is the inner surface of said resilient ring.

6. The assembly of claim 5 wherein said circumferential groove is a dovetail groove.

7. The assembly of claim 5 further comprising one or more circumferential protrusions on said first surface.

8. A method of increasing the available energy stored within a metal end cap seal having a resilient ring and metal end caps, when the metal end cap seal is compressed between and inner surface and an outer surface, by:
forming the resilient ring with a first side having a circumferential groove and a convex second side surface;
providing fluid communication between the groove with the second side surface;
applying a pressure to the seal and circumferential groove that is higher than a working pressure of the seal;
removing a pressure from the seal while retaining a higher pressure within the groove.

9. The method of claim 8 wherein said circumferential groove is a dovetail groove.
